(19) United States
(12) Patent Application Publication
(10) Pub. No.: US 2017/0261155 A1
(43) Pub. Date: Sep. 14, 2017

(54) WALL PLUG

(71) Applicants: Rafael Zvi Karl Kilim, London (GB); Simcha Izhak Kilim, London (GB)

(72) Inventors: Rafael Zvi Karl Kilim, London (GB); Simcha Izhak Kilim, London (GB)

(21) Appl. No.: 15/453,443

(22) Filed: Mar. 8, 2017

(30) Foreign Application Priority Data
Mar. 8, 2016 (GB) 1603983.6
Jun. 3, 2016 (GB) 1609752.9

(51) Int. Cl. F16M 13/02; F16B 2/08

(52) U.S. Cl. CPC F16M 13/02; F16B 2/08

(57) ABSTRACT

A wall plug 30 is provided with a longitudinal recess 34 along at least one side thereof for receipt therealong of the flexible tape portion of a cable tie.

An anchor is provided for securing a flexible cable tie to a hollow wall, the cable tie 3 having a head portion 18 containing a locking mechanism 20 and a flexible tape portion, for example provided with teeth 3a. The anchor comprises an elongate body 4 having a transverse aperture 11 therethrough at or adjacent to the mid-point of the length thereof, a first recess 14 extending along the body from the aperture to one end thereof, a second recess 12 extending along the opposite side of the body to the first recess from the aperture 11 towards the opposite end thereof and a slot 16 through said opposite end thereof communicating with the second recess. The tape portion of a cable tie may be passed through the slot, along the second recess, through the aperture and along the first recess, the head portion of the tie engaging the said opposite end of the body such that, when the anchor and tie are passed through a hole drilled in a hollow wall leaving a free end of the tape portion of the tie projecting from the hole, pulling on the free end of the tie will cause the anchor to rotate into engagement with the inner face of the hollow wall.

A fixing for mounting an object on a wall comprises a body 40 with a passage 41 therethrough containing a locking mechanism 42 for engagement with the flexible tape portion of a cable tie projecting from the wall and secured in the wall, mounting means on the body, and a resiliently deformable member 43 between the body and the wall.

### FIELD OF THE INVENTION

This invention relates to devices for attaching articles to walls using cable ties and in particular to wall plugs.

### BACKGROUND TO THE INVENTION

Cable ties are typically formed of nylon and consist of a flexible tape portion formed with teeth and a head portion containing a pawl that engages the teeth when the tape portion is looped back through the head portion to form a ratchet which permits tightening of the loop, but prevents its release. They have been available for many years and have been used for a wide variety of applications in addition to the original use for holding together bundles of wires or cables.

An alternative form of cable tie, particularly for use in installations where fire resistance is important, is formed of a flexible metal strip, for example stainless steel. There are two main forms of locking mechanism for metal cable ties: a ball-locking mechanism in which a free-moving ball is wedged between the interior of a tapering lock head and the cable tie to prevent its withdrawal; and a barb which is angled within the lock head to allow insertion but to cut into the cable tie to prevent release.

It has been proposed to use the ratchet principle of plastic cable ties to attach articles to a surface, for example a wall. For example, U.S.2011162171A1 discloses a toothed flexible strip similar to a cable tie, provided with a wedging head portion at one end which co-operates with a special wall plug. The strip passes through the wall plug with the wedging head of the strip inserted with the plug into a hole drilled in a wall. The strip is then pulled outwardly to draw the wedging head into the plug causing it to expand into firm engagement with the hole. A pawl inside the plug engages the teeth on the strip to lock the strip in position. Articles can then be mounted on the strip using mountings having pawls engageable with the strip in the same way as the head of a cable ties. For hollow wall fixing, there is disclosed deformable plug devices integrally formed with the strip such that, when the deformable plug device is inserted through a hole in, say, plasterboard, pulling on the strip causes the head to deform and engage the inner surface of the plasterboard, holding the strip in place. A similar arrangement is disclosed in U.S.2013298381A1 and in U.S. Pat. No. 4,865,501. U.S.2008250609 discloses a cable tie configured for attachment to a thin automotive panel. It has a deformable leg with springs out to engage the reverse side of the panel after the head of the tie is passed through an aperture in the panel, and flattenable support tabs which engage the external surface of the panel to hold the tie in place.

The prior art devices all require specially configured ties, so that if different lengths of tie are required for attaching different types of fitting, it is necessary to stock a range of such ties. Since cable ties are already widely available, it would be desirable to employ these, rather than have to create a range of new ties.

In addition, there is a need to provide reliably firm fixing of articles by ensuring that the cable tie is held under tension after fixing.

### SUMMARY OF THE INVENTION

According to one aspect of the invention there is provided a wall plug having an elongate body extending longitudinally between end portions, the elongate body being provided with at least one longitudinal recess extending therealong for receipt of a flexible tape portion of a cable tie

Another aspect of the invention provides a plastic wall plug provided with a flange portion at one end thereof and an expandable body portion extending from the flange portion, the flange portion incorporating an aperture at one side thereof aligned with a recess along the body portion, whereby a flexible plastics cable tie may be received in the recess to extend through the aperture.

A second recess and aperture may be disposed at the opposite side of the plug. The plug may further comprise a flattened loop molded onto the end thereof remote from the flange portion.

Yet another aspect of the invention provides an anchor for securing a flexible cable tie to a hollow wall, the cable tie having a head portion containing a locking mechanism and a flexible tape portion, the anchor comprising an elongate body having a transverse aperture therethrough at or adjacent to the mid-point of the length thereof, a first recess extending along the body from the aperture to one end thereof, a second recess extending along the opposite side of the body to the first recess from the aperture towards the opposite end thereof and a slot through said opposite end thereof communicating with the second recess, whereby the tape portion of a cable tie may be passed through the slot, along the second recess, through the aperture and along the first recess, the head portion of the tie engaging the said opposite end of the body such that, when the anchor and tie are passed through a hole drilled in a hollow wall leaving a free end of the tape portion of the tie projecting from the hole, pulling on the free end of the tie will cause the anchor to rotate into engagement with the inner face of the hollow wall.

The anchor may have a circular cross-section. The aperture may include a cross member extending therethrough. The anchor may be formed of plastic or of metal.

A further aspect of the invention provides a fixing for mounting an object on a wall, comprising a body with a passage therethrough containing a locking mechanism for engagement with the flexible tape portion of a cable tie projecting from the wall and secured in the wall, mounting means on the body, and a resiliently deformable member between the body and the wall.

The cable tie may be secured in the wall by a wall plug in accordance with the first aspect of the invention or by an anchor according to the second aspect of the invention.

The resiliently deformable member may be a flexible leg projecting from the body.

In another embodiment, the body comprises a first part containing the locking mechanism and a second part engageable with the wall, the resiliently deformable member being arranged between the parts. The resiliently deformable member may be a helical compression spring. The first and second parts may be relatively rotatable about the axis therethrough. Alternatively, the resiliently deformable member may comprise an integrally-molded spring arm extending between the first and second parts. Preferably a pair of the integrally-molded spring arms are used.

The mounting means can be any of a wide range of types of fitting, for example a cable clip, a pipe clip, a hook, a cable tray, a spring clip, an electrical mounting plate, a shelf bracket, a curtain rail support, or a part of a hook and loop attachment.

The locking mechanism may be a resiliently-mounted pawl for engagement with ribs or teeth along a plastic cable tie, or a ball-locking or barb-locking arrangement for a metal cable tie.

Dependable firm attachment of articles to a surface can be achieved rapidly with the fixings of the invention.

### BRIEF DESCRIPTION OF THE DRAWINGS

In the drawings, which illustrate exemplary embodiments of the devices according to the invention:

FIG. 1 is a cross-sectional elevational view of a cable fixed to a hollow wall using devices according to a first embodiment of the invention;

FIG. 2 is an isometric view of the arrangement shown in FIG. 1;

FIG. 3 is a cross-sectional view of the hollow-wall anchor of FIGS. 1 and 2, with the cable tie in a position ready for insertion into a hole in the wall;

FIG. 4 is an isometric view of the anchor of FIG. 3;

FIG. 5 is an isometric view corresponding to FIG. 3, showing the configuration of the cable tie after insertion in a hollow wall;

FIG. 6 is a cross-sectional view corresponding to FIG. 5;

FIG. 7 is a cross-sectional view corresponding to FIG. 6, but showing an alternative configuration of the cable tie.

FIG. 8 is an isometric view of a wall plug in accordance with another embodiment of the invention;

FIG. 9 is an isometric view showing the wall plug of FIG. 8 fitted with a cable tie;

FIG. 10 is an isometric view of the wall plug of FIG. 8, showing an alternative use of the wall plug in cooperation with a cable tie;

FIG. 11 is a cross-sectional view of the arrangement shown in FIG. 10;

FIG. 12 is a cross-sectional view of a cable clip for use with a fixing according to one embodiment of the invention;

FIG. 13 is an isometric view of the cable clip of FIG. 12;

FIG. 14 is a cross-sectional view of an alternative component of the fixing;

FIG. 15 is an isometric view of the component of FIG. 14;

FIG. 16 is a cross-sectional view of a cable clip for use with a fixing according to another embodiment of the invention;

FIG. 17 is an isometric view of the cable clip of FIG. 16;

FIG. 18 is an isometric view of a double pipe clip;

FIG. 19 is an isometric view of a picture grip;

FIG. 20 is an isometric view of a picture frame hook;

FIG. 21 is an isometric view of a cable tray;

FIG. 22 is an isometric view of a wall light fitting base;

FIG. 23 is an isometric view of a shelf bracket;

FIG. 24 is an isometric view of a curtain rail mount;

FIG. 25 is an isometric view of a pad for use with a hook and loop mounting;

FIG. 26 is an isometric view of a cable clip for use with a fixing according to a further embodiment of the invention;

FIG. 27 is a side elevation of the cable clip according to FIG. 26;

FIGS. 28 and 29 are isometric views of two molded components which can be fitted together to form a wall plug according to a still further embodiment of the invention;

FIGS. 30 and 31 are isometric views respectively from the flange end and from the opposite end of yet another configuration of wall plug according to the invention;

FIG. 32 is an isometric view of another form of wall plug;

FIG. 33 is an isometric part-sectioned view illustrating successive stages in the use of the wall plug of FIG. 32;

FIG. 34 is a sectional view corresponding to that of FIG. 7, with the wall plug adapted to accommodate two cable ties;

FIG. 35 is an isometric view of yet another embodiment of wall plug; and

FIG. 36 is a view corresponding to that of FIG. 13, showing a fitting adapted for use with metal cable ties.

### DETAILED DESCRIPTION OF THE ILLUSTRATED EMBODIMENT

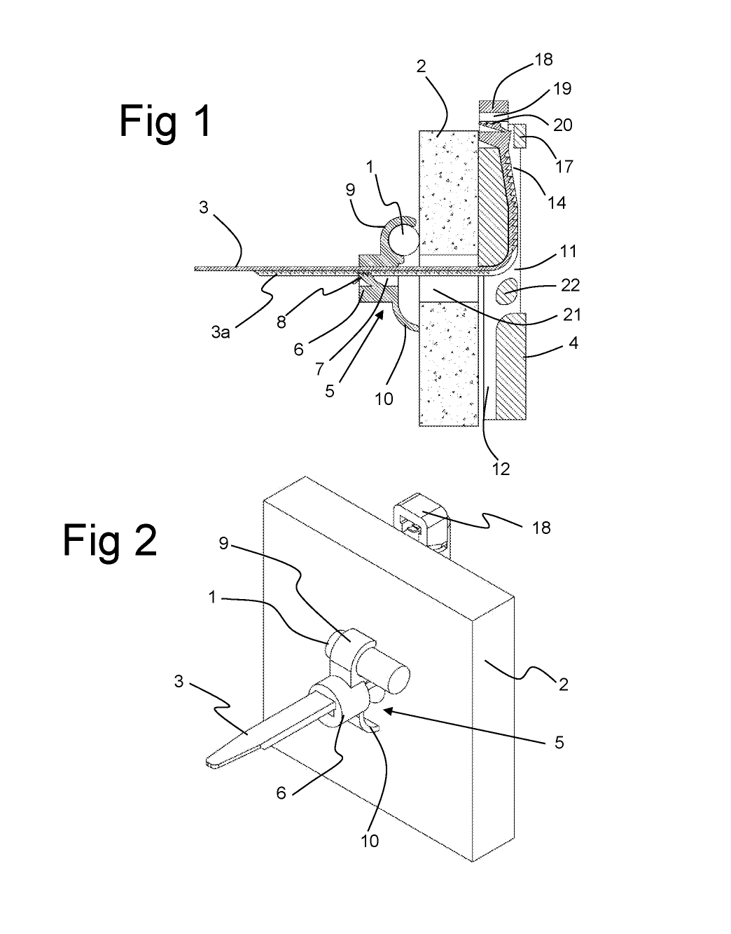

Referring first to FIG. 1, a cable 1 is fixed to a hollow wall, for example having a plasterboard skin 2, by a combination of a flexible plastic cable tie 3 held by an anchor 4 in the wall, the cable tie 3 engaging a cable clip 5. The cable clip 5 has a generally cylindrical body portion 6 having therethrough a cavity 7 containing a locking pawl 8 engageable with teeth 3a on the cable tie 3 passed through the cavity 7. The locking pawl 8 is configured to allow the cable tie 3 to be drawn is through the cavity 7 in one direction, but to lock it against movement in the opposite direction. The cable clip 5 has a cable-engaging portion 9 extending from one side of the body portion 6 and a resilient leg 10 extending from the opposite side so as to engage the face of the plasterboard 2.

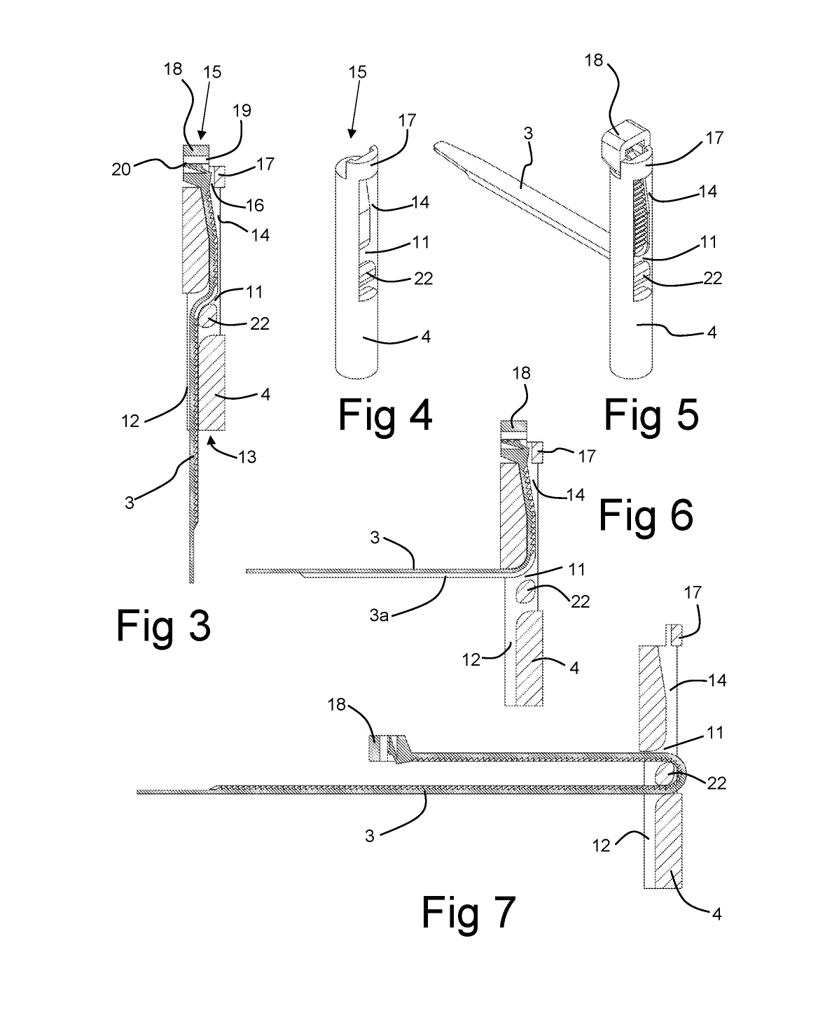

As may be seen from FIGS. 3 and 4, the anchor 4 is of elongate cylindrical form with a central transverse aperture 11 extending therethrough, the first recess 12 in the surface of the anchor 4 extending from the aperture 11 to one end 13 of the anchor 4 and a second recess 14 extending along the opposite side of the anchor 4 from the recess 11 towards the other end 15 of the anchor 4. The other end 15 of the anchor 4 has an opening 16 communicating with the second recess 14 and an upstand portion 17. The cable tie 3 has, in conventional manner, a head portion 18 having an aperture 19 therethrough containing a locking pawl 20 so that the free end of the cable tie can be looped back to pass through the aperture 19, the teeth 3a being engaged by the locking pawl 20 in such a manner as to prevent the loop being opened up, but only permitting it to be tightened. In the arrangement illustrated in FIGS. 1 to 6 this head portion 18 is trapped by the upstand portion 17 of the anchor 4, the flexible tape portion of the cable tie 3 extending along the second recess 14, through the aperture 11, and then out through a hole 21 drilled in the plasterboard 2 to pass through and engage with the cable clip 5.

FIG. 3 illustrates the initial state of the anchor 4 and the cable tie 3 before insertion through the hole 21 in the plasterboard 2. The tape portion of the cable tie 3, after passage through the aperture 11, is received in the first recess 12 along the length of the anchor 4. The cable tie 3 therefore does not extend outside the cylindrical diameter of the anchor 4, permitting it to be passed through the hole 21, with the free end of the cable tie 3 extending from the hole. Once the entire anchor 4 has passed through the hole, it can engage the inner surface of the plasterboard 2 such that pulling on the cable tie 3 causes the anchor 4 to rotate to the position illustrated by FIGS. 1, 5 and 6, so that the anchor bears against the inner surface of the plasterboard 2.

To secure the cable clip 5, it is threaded onto the cable tie 3 projecting from the hole 21. With the cable 1 engaged by the portion 9, the free end of the cable tie 3 is held under tension while the cable clip 5 is pushed towards the surface of the plasterboard 2. This causes the resilient leg 10 to deflect, while engagement of the locking pawl 8 with the teeth 3a on the cable tie prevents the cable tie being released, the resilience of the leg 10 maintaining the tension in the cable tie, and thus holding the cable 1 firmly in place against the plasterboard 2. Once the cable is firmly clamped in place, the free end of the cable tie 3 can be cut off.

FIG. 7 illustrates an alternative way in which the cable tie 3 can be anchored by the anchor 4. A shaped post 22 extends transversely across the aperture 11 in the anchor 4. The cable tie 3 is looped around the post 22, and for the purposes of insertion through a hole 21 in the plasterboard 2 both layers of the cable tie are located in the first recess 12 while the anchor is passed through the hole 21. When the anchor 4 is fully within the hollow wall, pulling on both ends of the cable tie 3 will again cause it to rotate into engagement with the inner surface of the plasterboard 2. The cable tie can then be employed in conventional manner to fasten an object to the outer face of the plasterboard wall, looping the free end of the cable tie through the head portion 18 to be locked by the pawl 8.

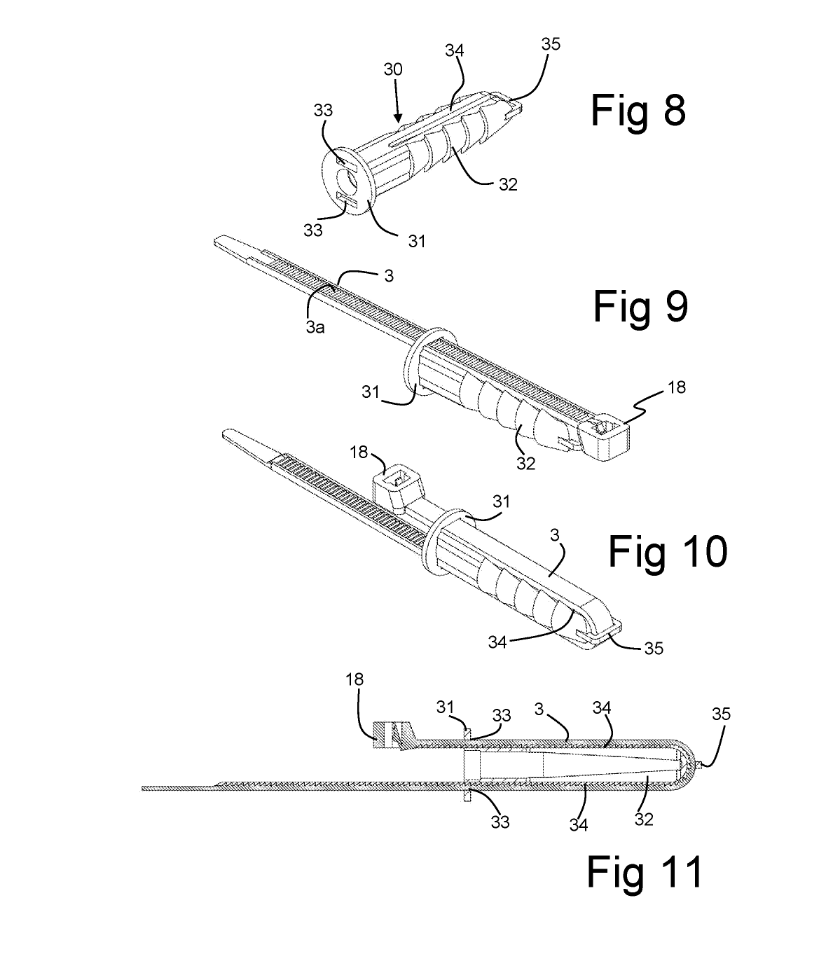

FIG. 8 illustrates a plastic wall plug 30 modified in accordance with an alternative embodiment of the invention to cooperate with a conventional plastics cable tie. The wall plug 30, suitably formed from a resilient plastics material such as nylon, has a flange portion 31 at one end intended to bear against the surface in which it is inserted, and a bifurcated body portion 32 having an external toothed formation to bear against and grip the internal surface of a hole in which it is inserted in use. The flange portion 31 is provided with two diametrically opposed slots 33 therethrough, each slot opening into a recess 34 along the body portion 32 spanning the bifurcation. A rectangular loop 35 is formed at the end of the body portion remote from the flange portion 31, the loop projecting in an axial direction relative to the longitudinal axis of the plug. FIG. 9 illustrates one way in which the wall plug of this aspect of the invention can be used with a cable tie 3 of conventional form. The cable tie is extended along the recess 34 on one side of the wall plug 30 and through the corresponding slot 33, with the head portion 18 of the cable tie 3 resting against the loop 35. The wall plug and cable tie and then inserted in this configuration into a hole drilled into a surface, and the wall plug is then secured in position by driving a screw into it. This causes expansion of the bifurcated body portion 32 into engagement with the surfaces of the hole in conventional manner. The cable tie is thus anchored in position and can be used for securing fixings, for example the cable clip 5 illustrated in FIGS. 1 and 2.

FIGS. 10 and 11 illustrate an alternative use of the wall plug for cooperation with a cable tie in the manner described with reference to FIG. 7. The cable tie 3 is looped through one slot 33 in the wall plug 30, along the corresponding recess 34, through the loop 35, back along the opposite recess 34 and out through the slot 33 corresponding to that recess. The wall plug and its associated cable tie are then inserted into a hole in the surface, and an item can then be secured to that surface using the cable tie in the conventional manner.

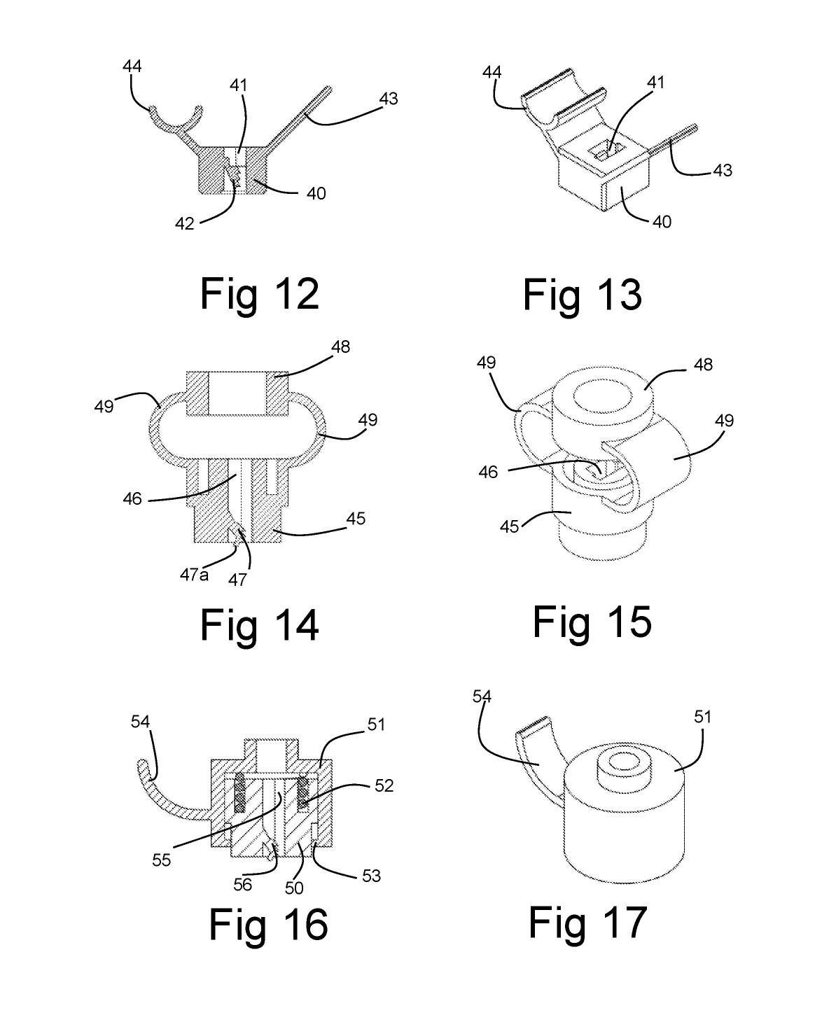

FIGS. 12 to 25 illustrate various fixings in accordance with one aspect of the invention. FIGS. 12 and 13 show a cable clip having a molded plastic body 40 with a passage 41 therethrough, the passage 41 containing a resiliently molded locking pawl 42 engageable with the teeth on a cable tie passed through the passage. A resiliently deflectable arm 43 extends from one end of the body 40 to engage the wall on which the fixing is to be secured, while a cable-retaining member 44 extends from the same end but at the opposite side to engage a cable and hold it against the wall. In use, the cable tie is tensioned by pulling on it while pressing the fixing against the wall so as to deflect the arm 43 outwardly and clamp the cable against the wall. Engagement of the locking pawl 42 then holds the fixing in place on the cable tie with the arm providing the tension to hold the fixing securely in place.

FIGS. 14 and 15 illustrate an alternative arrangement in which the body is formed in two parts, the first part 45 having a passage 46 therethrough containing the locking pawl 47, and the second part 48 being of annular form spaced axially from the first part 45 and connected thereto by curved the resilient arms 49, one on each side of the axis. In use, with the second part 48 pressed against the wall, the cable tie is drawn through the passage 46 and the first part 45 is pressed towards the second part 48 causing resilient flexure of the arms 49. With the locking pawl 47 engaging the cable tie, the flexure of the arms maintains the tension in the cable tie to hold the fixing firmly in place. The locking pawl is provided with a small tab 47a which projects from the end of the passage 46, enabling the user to deflect the pawl manually to release the cable tie if it is desired to remove the fixing from the wall.

FIGS. 16 and 17 illustrate yet another arrangement in which the body of the fixing comprises two parts. In this case, the first part 50 is slidable within the second part 51 with a helical compression spring 52 between the two parts. The first and second parts 50 and 51 are generally cylindrical, the second part 51 having a cylindrical bore therein in which the first part 50 is a sliding fit. The first part has a stepped cylindrical outer surface, while the second part has at one end and inwardly direct did flange 53 which acts with the step on the first part 52 retain the first part within the second part 51. The second part 51 has a molded cable clamp 54 extending therefrom. The first part 50 has a passage 55 therethrough containing a locking pawl 56. Tensioning of the cable tie is carried out in generally the same manner as described with reference to FIGS. 12 to 15, the spring 52 being compressed to provide the tension. This particular configuration permits relative rotation of the two parts so that the final alignment of the cable clamp 54 is not dependent on the correct alignment of the cable tie when it is secured in the wall.

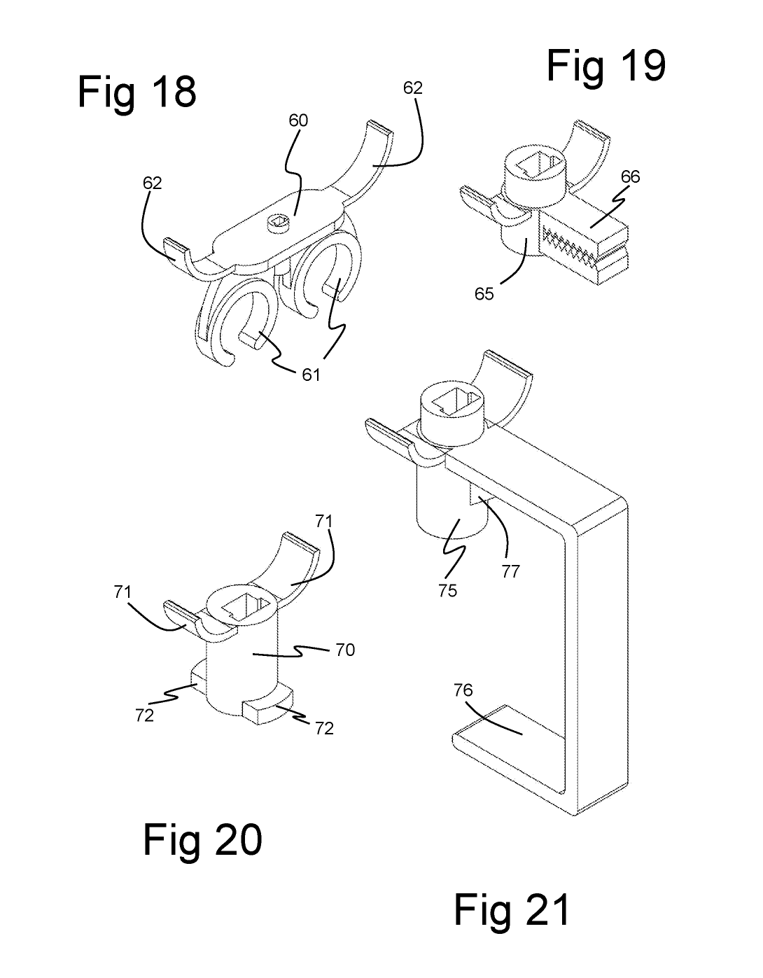

FIGS. 18 to 21 illustrate adaptations of the structure of FIGS. 12 and 13 to various different functions. In FIG. 18, the body 60 is extended to mount a pair of pipe clips 61, again the resilient arms 62 enabling tensioning of the cable tie to hold the structure firmly in place. FIG. 19 shows the body 65 mounting a toothed resilient clip 66 for temporary receipt of a sheet of paper or card, for example for the temporary display of a picture. FIG. 20 shows a picture hook, in which the body 70 is provided at the end remote from the resilient arms 71 with hook formations 72. In the embodiment shown in FIG. 21, the body 75 mounts a cable tray 76 for supporting a run of cables along the wall. A diagonal stiffening member 77 ensures suitable rigidity.

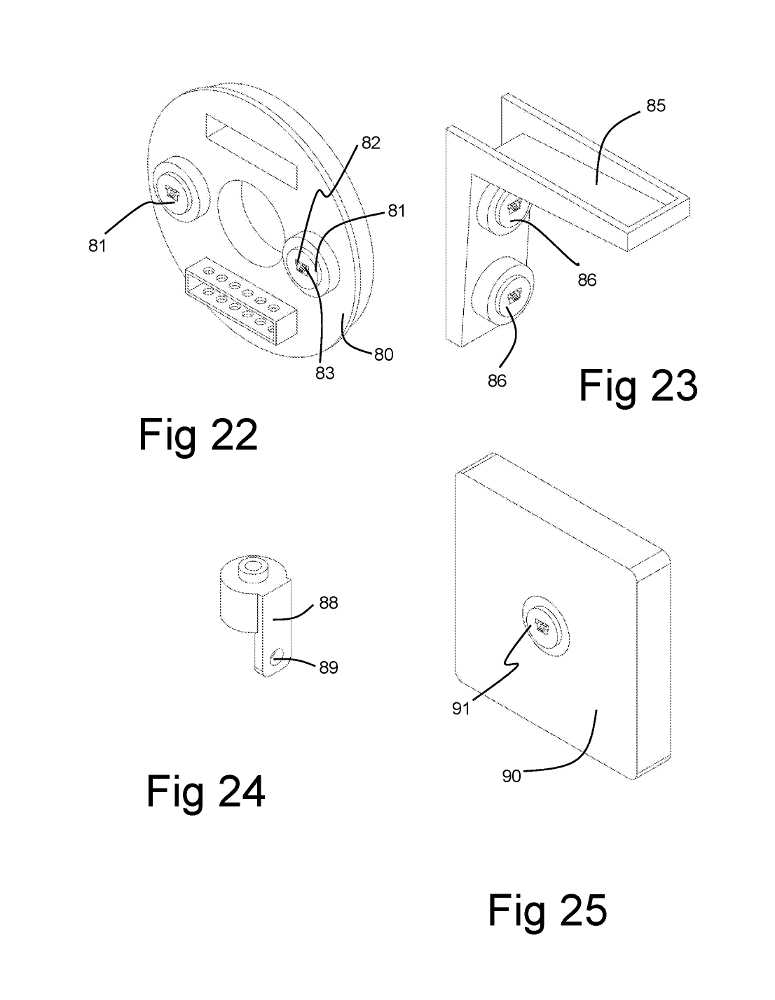

FIG. 22 illustrates an electrical baseplate, for example for a wall light fitting, having a circular body 80 provided with a spaced pair of mountings 81 each having a passage 82 therethrough containing a locking pawl 83 for engagement with a cable tie fixed in the wall. Each of the mountings 81 may be formed in the general manner disclosed in relation to FIGS. 16 and 17, the sprung second parts (not shown) engaging the wall surface. FIG. 23 shows a shelf bracket 85 having a pair of mountings 86 of the same structure as the mountings 81 in FIG. 22. FIG. 24 illustrates a fixing of the type shown in FIGS. 16 and 17, adapted for the mounting of a curtain rail by the provision of a forwardly projecting arm 88 with a fixing hole 89 for attachment of the curtain rail. FIG. 25 illustrates a mounting pad for the temporary attachment of articles using a hook and loop mounting arrangement, for example that sold under the registered trademark Velcro. The pad 90 is provided with a surface constituted by either the hooks or the loops of a hook and loop fixing, with a mounting of the general type disclosed in relation to FIGS. 16 and 17 located centrally thereof.

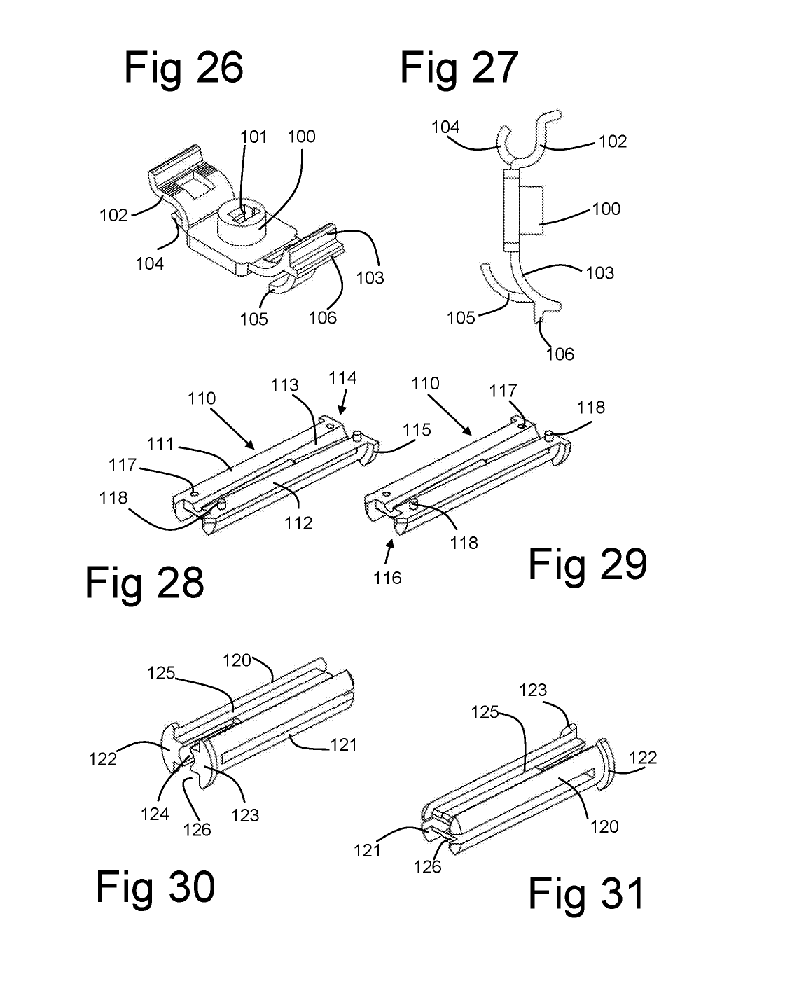

FIGS. 26 and 27 show a multi-purpose fixing having a body portion 100 with an aperture 101 extending therethrough and containing a locking pawl as hereinbefore described with reference to other configurations of fixing. Two resiliently deflectable arms 102 and 103 are integrally molded with the body portion 100. The upper arm 102 is provided with a cable-retaining formation 104 into which a cable may be located, while the lower arm 103 is provided with a hook formation 105, permitting the fixing to be used, for example for mounting pictures. The fixing can alternatively be used to retain an article against the wall by locating the article between the lower am 103 and then tensioning the fixing in the manner hereinbefore described. The article can then be released by lifting a tab 106 provided on the lower arm 103. It will be appreciated that “upper” and “lower” are used as convenient descriptions for the arms relating to the orientation when the device is mounted on a vertical wall. However, the fixing may be used in other orientations.

FIGS. 28 and 29 illustrate an alternative configuration of wall plug according to the invention. For ease of manufacture, the wall plug may be manufactured as identically-molded halves 110 as illustrated, although it will be appreciated that the halves 110 could be molded as pairs joined by a thin longitudinal web. Each half 110 comprises two flat faces 111 and 112 separated by a groove 113 tapering from a first end 114 provided with flange formations 115 towards a second end 116. One flat face 111 is provided with a pair of locating holes 117, while the other flat face 112 is provided with a pair of corresponding locating pins 118 upstanding therefrom, the pins 118 of one half 110 being an interference fit in the holes 117 of another half 110 fitted together with the first to form the wall plug. Each half 110 has a recess 119 along the face opposite to the flat faces 111 and 112, sized to accommodate the flexible tape portion of a conventional cable tie. A manner of use of this wall plug will be described hereinafter with reference to FIGS. 30 and 31.

The wall plug illustrated in FIGS. 30 and 31 is similar in configuration to that formed from the two halves brought together as described with reference to FIGS. 28 and 29, but is integrally-molded so that two half bodies 120 and 121 are separated longitudinally one from the other, but joined together at one end by a pair of flange formations 122 and 123 spaced apart by a central aperture 124, thus providing for expansion in two directions when a screw is driven into the wall plug, in use. Each half body 120 and 121 has a recess 125 and 126 respectively along its outer surface in which the flexible tape portion of a conventional cable tie can be accommodated.

The wall plugs of FIGS. 28 and 29, or FIGS. 30 and 31, can be used in conjunction with a cable tie, as follows. The cable tie is first inserted into the pre-drilled hole in a surface, either with the head portion inserted first, or by bending the cable tie and pushing the bent end into the hole. The wall plug is then inserted into the hole in such a manner that the tape portion extends along one or both recesses and projects from the hole. A screw is then driven into the wall plug to expand the plug so that it grips the sides of the hole and also grips the cable tie, securing it in place.

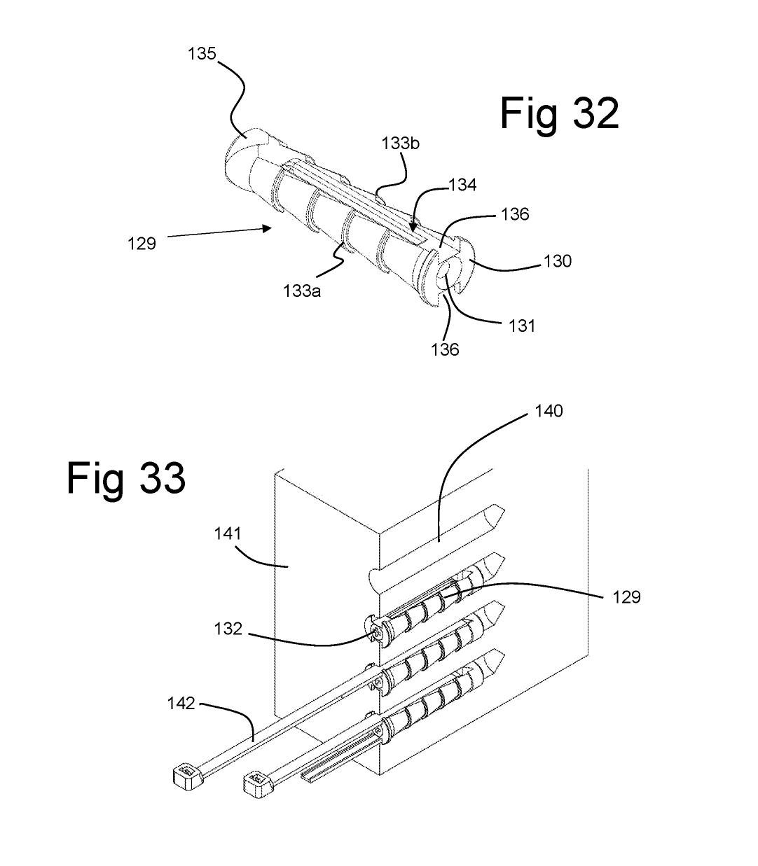

FIG. 32 shows a wall plug 129 of the general type shown in FIGS. 8 to 11, with a flange portion 130 at one end having a central aperture 131 through which a fixing screw 132 (FIG. 33) may be driven. The body 133 of the plug extending from the flange portion 130 is provided with a longitudinal slot 134 therethrough permitting the opposed portions 133a and 133b of the body to expand outwardly as the screw 132 is driven into the plug. The exteriors of the portions 133a and 133b are configured to provide a series of frusto-conical sections which tend to assist insertion into a bore and to resist removal therefrom. The end remote from the flange is formed with a cap 135 connecting the two portions 133a and 133b of the body. A recess 136 extends along each side of the body spanning the slot 134.

Referring to FIG. 33, illustrating successive stages in the use of the wall plug of FIG. 32, a bore 140 is drilled into a masonry body, shown sectioned for clarity. The wall plug 129 is pushed into the bore 140 and a screw 132 is driven into it, causing the two portions 133a and 133b of the body to expand outwardly to grip the bore and hold the wall plug in position. A cable tie 142 is then inserted into the recess 136 on one side of the flange portion 130 of the wall plug 129. The free end of the cable tie comes into engagement with the inner surface of the cap 135, which is smoothly curved so as to guide the cable tie end through 180 degrees so that it is directed back along the opposite recess 136 to emerge through the flange on the opposite side from the point of entry. It can then be used for attachment of cables to a wall, for example. By passing the cable tie through a hole in the rear face of cable ducting before fastening around cable in the ducting, the cable tie can also serve to hold the ducting in position.

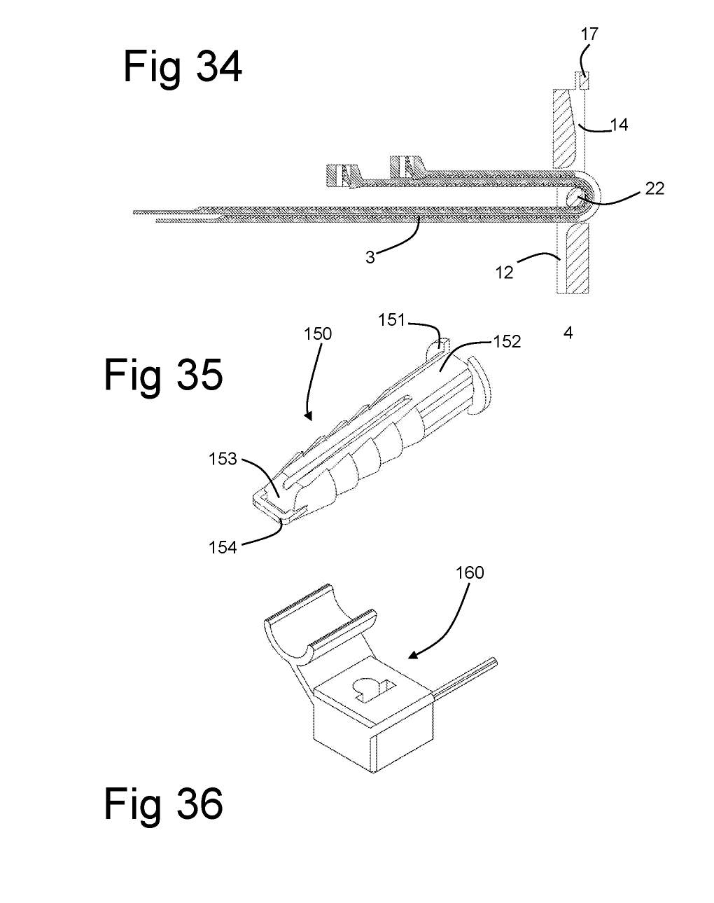

FIG. 34 illustrates a modification of the anchor shown in FIG. 7 to accommodate two cable ties to permit, for example, the separate fastening of two or more cables in two successive stages. The recesses 12 and 14 are formed with sufficient depth to accommodate the two cable ties during insertion and the aperture 11 is similarly enlarged.

The wall plug 150 of FIG. 35 differs from that shown in FIGS. 8-11 in that the flange portion 151 is cut away to allow access to the recesses 152, while the end 153 of the plug remote from the flange 151 is smoothly rounded so that a cable tie passing through the loop 154 is readily adjustable in position.

While the embodiments illustrated in the drawings are mostly illustrated as configured for use with plastic cable ties, it will be appreciated that they can be readily adapted for use with metal cable ties. FIG. 36 shows a variant 160 of the cable clip of FIG. 13, formed of stainless steel, for example, and incorporating a ball locking system for engagement with a metal cable tie, so that, when the cable tie passes through the clip and the clip is pushed firmly against the surface in which the cable tie is secured, while holding the tie in tension, the ball engages and clamps the tie, locking it in place and thus holding the cable clip 160 firmly against the surface.

We claim:

1. A wall plug having an elongate body extending longitudinally between end portions, the elongate body being provided with at least one longitudinal recess extending therealong for receipt of a flexible tape portion of a cable tie.

2. The wall plug of claim 1, having a flange portion at one end thereof, the recess extending through the flange portion.

3. The wall plug of claim 1, having longitudinal recesses disposed along two opposed sides of the body.

4. The wall plug of claim 3, comprising a flattened loop formed in the end thereof remote from the flange portion.

5. The wall plug of claim 2, having longitudinal recesses disposed along two opposed sides thereof.

6. The wall plug of claim 5, comprising a flattened loop formed in the end thereof remote from the flange portion.

7. The wall plug of claim 1, formed as a pair of identical plastic moldings, each constituting a longitudinally-separated half of the wall plug and having a longitudinal face which can be brought into contact with the longitudinal face of the other molding to form the wall plug, each said longitudinal face being provided with formations thereon engageable with the formations on the longitudinal face of the other molding to hold the two moldings together.

8. The wall plug of claim 7, wherein the formations on each longitudinal face comprise projections and recesses, the projections on one longitudinal face being an interference fit in the recesses on the longitudinal face of the other molding.

9. The wall plug of claim 7, wherein the pair of moldings is joined together by a flexible web along edges of the respective longitudinal faces, the flexible web permitting the longitudinal faces to be brought into contact with each other.

10. The wall plug of claim 5, wherein the elongate body comprises a longitudinal slot therethrough extending between the two recesses from a position adjacent to one end portion and opening through the other end portion, thereby permitting expansion of the body as a screw is driven into the wall plug.

11. The wall plug of claim 1, formed as an integral plastic molding.

12. The wall plug of claim 3, wherein the end portions comprise a head end portion adapted to engage a wall surface when the plug is inserted into a hole drilled in the wall, and a tail end portion remote therefrom, the tail end portion having a curved surface therein linking said longitudinal recesses whereby a flexible cable tie inserted along one of said longitudinal recesses from said head end portion when the wall plug is located in a hole drilled in a wall is guided by said curved surface back into the other of said longitudinal recesses to emerge at said head end portion.
